(19) United States
(12) Patent Application Publication
(10) Pub. No.: US 2026/0280125 A1
(43) Pub. Date: Sep. 17, 2026

(54) END LOOP ANTENNA

(71) Applicant: KYOCERA AVX Components (San Diego), Inc., San Diego, CA (US)

(72) Inventor: Weichun Eric Lin, San Diego, CA (US)

(21) Appl. No.: 19/569,101

(22) Filed: Mar. 17, 2026

Related U.S. Application Data
(60) Provisional application No. 63/773,066, filed on Mar. 17, 2025.

(51) Int. Cl. H01Q 7/00; H01Q 5/20

(52) U.S. Cl. CPC H01Q 7/00; H01Q 5/20

(57) ABSTRACT

An antenna system is provided. The antenna assembly includes a cable antenna. The cable antenna includes an extended antenna portion configured to receive radio frequency signals, a connecting cable portion configured to connect the cable antenna to a device, and an antenna loop between the extended antenna portion and the connecting cable portion, the antenna loop comprising one or more loops of the cable antenna.

### PRIORITY CLAIM

The present application is based on and claims priority to United States Provisional Application 63/773,066 having a filing date of March 17, 2025, which is incorporated by reference herein.

### FIELD

The present disclosure relates generally to an antenna assembly, and more specifically to a cable antenna including an antenna loop.

### BACKGROUND

Antennas can be used to facilitate wireless communication between devices. It can be desirable for antennas to operate with a high efficiency to improve wireless communication between devices. Antennas may be incorporated into a variety of different types of electronic devices to provide for wireless communication. An antenna assembly may include one or more antennas to facilitate wireless communication over a variety of different frequency bands/protocols.

### SUMMARY

Aspects and advantages of embodiments of the present disclosure will be set forth in part in the following description, or can be learned from the description, or can be learned through practice of the embodiments.

One example aspect of the present disclosure is directed to an antenna system. The antenna system includes a cable antenna, the cable antenna including an extended antenna portion configured to receive radio frequency signals, a connecting cable portion configured to connect the cable antenna to a device, and an antenna loop between the extended antenna portion and the connecting cable portion, the antenna loop including one or more loops of the cable antenna.

Another example aspect of the present disclosure is directed to an antenna system. The antenna system includes a cable antenna, the cable antenna including an extended antenna portion, a connecting cable portion, and an antenna loop between the extended antenna portion and the connecting cable portion, the antenna loop including one or more loops of the cable antenna, and an antenna loop support configured to retain the antenna loop in a looped configuration.

Another example aspect of the present disclosure is directed to an antenna system. The antenna system includes a circuit board, a first antenna electrically connected to the circuit board, a wire harness including one or more electrical cables, and a cable antenna, the cable antenna including an extended antenna portion configured to receive radio frequency signals, a connecting cable portion configured to connect the cable antenna to the circuit board, and an antenna loop between the extended antenna portion and the connecting cable portion, the antenna loop including one or more loops of the cable antenna.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 provides a single grounded antenna system according to example embodiments of the present disclosure;

FIG. 2 provides an illustrative diagram of a single grounded antenna efficiency according to example embodiments of the present disclosure;

FIG. 3 provides a double grounded antenna system according to example embodiments of the present disclosure;

FIG. 4 provides an illustrative diagram of a double grounded antenna efficiency according to example embodiments of the present disclosure;

FIG. 5 provides a loop antenna system according to example embodiments of the present disclosure;

FIG. 6 provides a detailed view of an antenna loop according to example embodiments of the present disclosure;

FIG. 7 provides a loop antenna system including a loop support according to example embodiments of the present disclosure;

FIG. 8 provides an illustrative diagram of loop antenna efficiencies across multiple antenna loop diameters according to example embodiments of the present disclosure;

FIG. 9 provides a molded antenna loop system according to example embodiments of the present disclosure;

FIG. 10A provides an attached molded antenna loop system according to example embodiments of the present disclosure;

FIG. 10B provides an embedded molded antenna loop system according to example embodiments of the present disclosure;

FIG. 11 provides an illustrative diagram of loop antenna efficiencies across multiple antenna angles according to example embodiments of the present disclosure;

Repeat use of reference characters in the present specification and drawings is intended to represent same or analogous features or elements of the invention.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations. As used herein, the use of the term “about” in conjunction with a numerical value refers to a value that falls within 10% of the stated numerical value.

The use of a long cable for a cable antenna system can cause signal attenuation, degrading the signal and lowering the signal efficiency (e.g., the percentage of electrical power fed into the antenna that is successfully converted into radio waves rather than being lost as heat or reflection). While additional grounding can improve efficiency moderately (e.g., from about 10% to about 25%), additional grounding adds significant manufacturing complexity and cost due to the additional soldering and components required. Therefore, a method for increasing the signal efficiency for a cable antenna system with a long cable connection is desirable.

Example aspects of the present disclosure relate generally to an antenna system that utilizes an isolated magnetic decoupler to overcome signal degradation in long cables without the need for additional physical grounding points on the cable antenna. In one embodiment, a cable antenna is formed into an antenna loop located between the extended antenna portion and the connecting cable portion of the cable antenna. The antenna loop can comprise about one and a half loops of the cable antenna, and can magnetically decouple the length of the cable, increasing the efficiency of the received radio frequency signal. To maintain the shape of the antenna loop, the cable antenna can utilize an antenna loop support, such as a plastic puck, clip, or injection-molded feature, to secure the shape.

The antenna system according to example aspects of the present disclosure provides numerous technical benefits. For example, the isolated magnetic decoupler can achieve an improvement in efficiency, such as an efficiency of about 55% to about 75%. In some embodiments, the isolated magnetic decoupler can also isolate the radio frequency signal received by the cable antenna from another nearby signal, such as from an adjacent antenna. Furthermore, this configuration offers a significant manufacturing advantage by eliminating the need for soldering separate ground clips to the cable, as the antenna loop structure increases the efficiency of the received signal. Additionally, the design allows for flexible placement, such as being zip-tied externally to a wire harness or embedded within it.

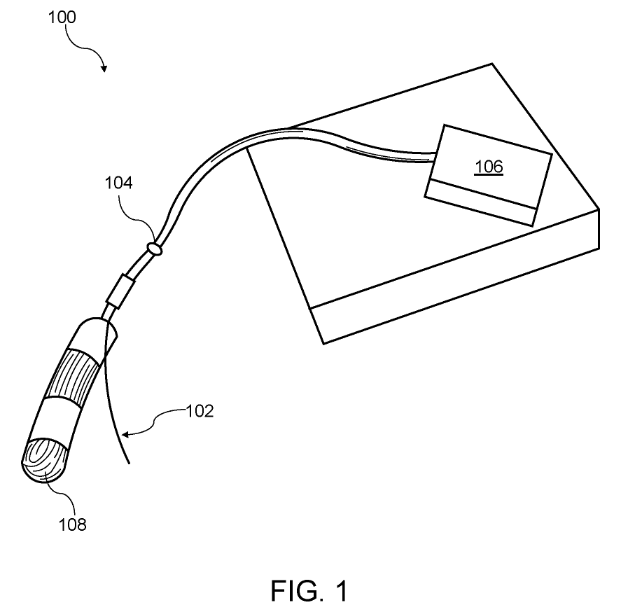

FIG. 1 provides a single grounded antenna system according to example embodiments of the present disclosure. In some embodiments, a single grounded antenna system 100 can include a cable antenna 102. The cable antenna 102 can be a flexible coaxial cable including a Teflon outside coating. For example, the cable antenna 102 can be a radio guide antenna (e.g., RG-174, RG-316, or RG-58), a low loss antenna (e.g., LMR-100 or LMR-240), or a micro-coaxial cable (e.g., a 1.13mm or 1.32mm cable). In some embodiments, the cable antenna 102 can be a semi-rigid coaxial cable including a solid metal outer sheath (e.g., copper or aluminum). In some embodiments, the cable antenna 102 can be a conformable coaxial cable (e.g., a tin-filled copper braid). In some embodiments, the cable antenna 102 can be a rigid line antenna (e.g., comprising solid copper tubes).

The cable antenna 102 can enable wireless communication for a variety of radio frequency (RF) bands. Aspects of the present disclosure are discussed with respect to example frequency ranges. Those of ordinary skill in the art, using the disclosures provided herein, will understand that the present technology can be used with other frequency ranges without deviating from the scope of the present disclosure.

In some embodiments, the cable antenna 102 can be configured to receive an RF signal such as an Extremely Low Frequency (ELF) band, including a frequency of about 3Hz to about 30Hz, such as a Super Low Frequency (SLF) band, including a frequency of about 30Hz to about 300Hz, such as a Ultra Low Frequency (ULF) band, including a frequency of about 300Hz to about 3kHz, such as a Very Low Frequency (VLF) band, including a frequency of about 3kHz to about 30kHz, such as a Low Frequency (LF) band, including a frequency of about 30kHz to about 300kHz, such as a Medium Frequency (MF) band, including a frequency of about 300kHz to about 3MHz, such as a High Frequency (HF) band, including a frequency of about 3MHz to about 30 MHz, such as a Very High Frequency (VHF) band, including a frequency of about 30MHz to about 300MHz, such as a Ultra High Frequency (UHF) band, including a frequency of about 300MHz to about 1GHz (IEEE) or up to about 3GHz (ITU).

In some embodiments, the cable antenna 102 can be configured to receive an RF signal in the microwave and radar spectrum, such as the S band, including a frequency of about 2GHz to about 4GHz, such as the C band.

In some embodiments, the cable antenna 102 can be configured to receive an RF signal in the GNSS range, such as the L1 band, centered at a frequency of about 1575.42MHz, such as the L2 band, centered at a frequency of about 1227.60MHz, such as the L3 band, centered at a frequency of about 1381.05MHz, such as the L4 band, centered at a frequency of about 1379.91MHz, such as the L5 band, centered at a frequency of about 1176.45MHz.

In some embodiments, the cable antenna 102 can be connected to a device 106 with a first ground 104 on a cable side of the cable antenna 102. The device 106 can be an electronic unit, that serves as the central processing hub for the signals received by the cable antenna 102. The device 106 can be connected to the cable antenna 102, enabling the transmission and reception of wireless signals. In some embodiments, the device 106 can be powered by device cables 108 including power supply lines for the device 106. In some embodiments, the device 106 can manage wireless data, such as Long Range (LoRa) or LTE signals, while providing the electrical grounding connection (e.g., first ground 104) to maintain signal efficiency.

In some embodiments, the first ground 104 can be integrated along the length of the cable antenna 102. The first ground 104 can be a soldered connection or a conductive strip that electrically connects the cable antenna 102 to a ground reference. In this way, the first ground 104 can mitigate signal attenuation caused by the long cable length, functioning as a tuning element to improve the cable antenna’s 102 efficiency. In configurations without an isolated magnetic decoupler (e.g., antenna loop), this grounding point can raise performance levels above the baseline efficiency of an ungrounded long cable.

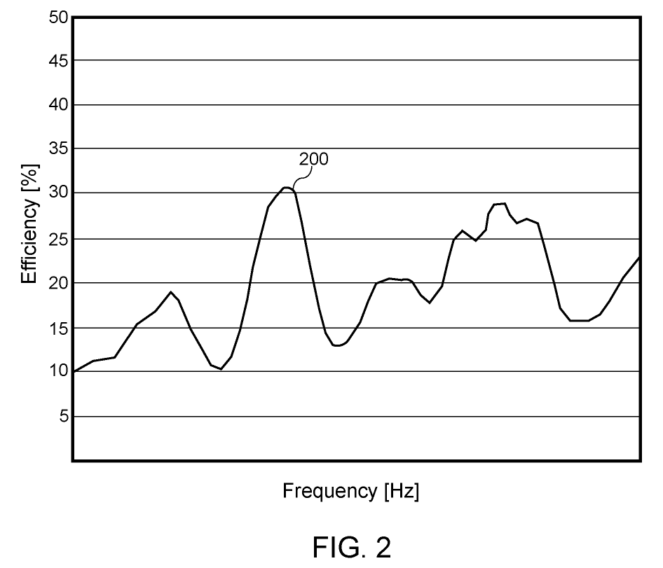

FIG. 2 provides an illustrative diagram of a single grounded antenna efficiency according to example embodiments of the present disclosure. The single grounded antenna efficiency 200 illustrates the performance metrics of the single grounded antenna system 100 when configured with a single grounding point (e.g., first ground 104) along its length. In some embodiments, at about 868MHz, the single grounded antenna system 100 has an efficiency of about 25%, while at about 915MHz, the efficiency decreases to roughly 20%. This efficiency curve demonstrates that while grounding provides some improvement over a non-grounded cable, the signal performance remains relatively limited due to attenuation from the long cable length.

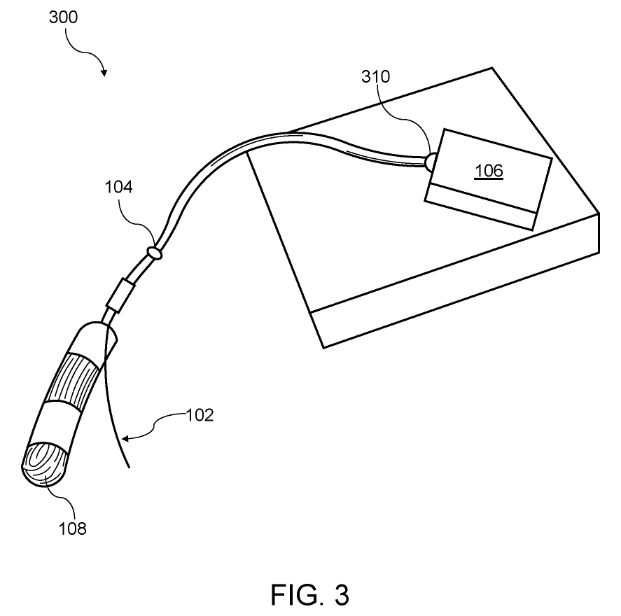

FIG. 3 provides a double grounded antenna system according to example embodiments of the present disclosure. In some embodiments, a double grounded antenna system 300 can include a cable antenna 102. The cable antenna 102 can be a flexible coaxial cable including a Teflon outside coating. For example, the cable antenna 102 can be a radio guide antenna (e.g., RG-174, RG-316, or RG-58), a low loss antenna (e.g., LMR-100 or LMR-240), or a micro-coaxial cable (e.g., a 1.13mm or 1.32mm cable). In some embodiments, the cable antenna 102 can be a semi-rigid coaxial cable including a solid metal outer sheath (e.g., copper or aluminum). In some embodiments, the cable antenna 102 can be a conformable coaxial cable (e.g., a tin-filled copper braid). In some embodiments, the cable antenna 102 can be a rigid line antenna (e.g., comprising solid copper tubes). The cable antenna 102 can enable wireless communication for a variety of radio frequency (RF) bands, such as the RF bands disclosed with respect to FIG. 1 (above).

In some embodiments, the cable antenna 102 can be connected to a device 106 with a first ground 104 on a cable side of the cable antenna 102. The device 106 can be an electronic unit, that serves as the central processing hub for the signals received by the cable antenna 102. The device 106 can be connected to the cable antenna 102, enabling the transmission and reception of wireless signals. In some embodiments, the device 106 can be powered by device cables 108 including power supply lines for the device 106. In some embodiments, the device 106 can manage wireless data, such as LoRa or LTE signals, while providing the electrical grounding connection (e.g., first ground 104) to maintain signal efficiency.

In some embodiments, the first ground 104 can be integrated along the length of the cable antenna 102. The first ground 104 can be a soldered connection or a conductive strip that electrically connects the cable antenna 102 to a ground reference. In this way, the first ground 104 can mitigate signal attenuation caused by the long cable length, functioning as a tuning element to improve the cable antenna’s 102 efficiency. The double grounded antenna system 300 can include a second ground 310 located at an end of the cable antenna 102 (such as at an end of the connecting cable portion), where the cable antenna 102 connects to the device 106. In combination with the first ground 104, the second ground 310 serves to further increase the efficiency of the cable antenna 102.

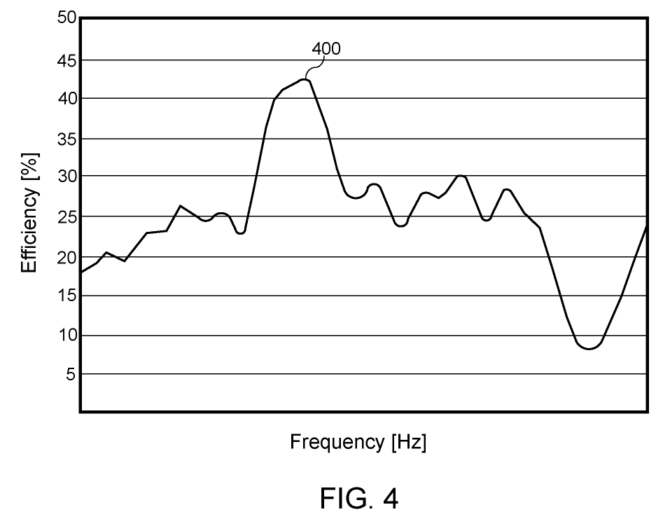

FIG. 4 provides an illustrative diagram of a double grounded antenna efficiency according to example embodiments of the present disclosure. The double grounded antenna efficiency 400 illustrates the performance metrics of the double grounded antenna system 300 when configured with two grounding points (e.g., first ground 104 and second ground 310). In some embodiments, at about 868MHz, the double grounded antenna system 300 has an efficiency of about 33%, while at about 915MHz, the efficiency decreases to roughly 28%. This efficiency curve demonstrates that while additional grounding provides some improvement over a non-grounded cable and a cable with a single ground, the signal performance remains relatively limited due to attenuation from the long cable length.

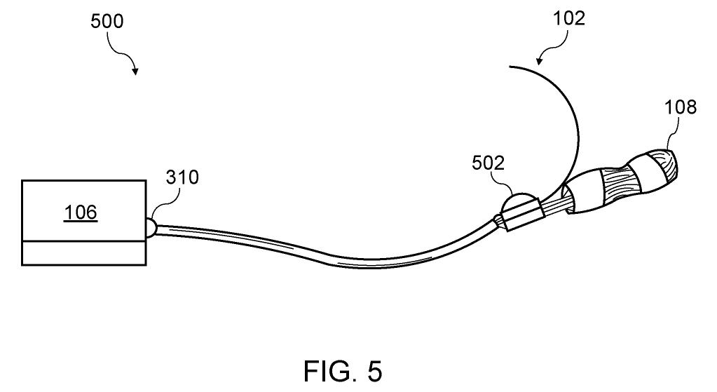

FIG. 5 provides a loop antenna system according to example embodiments of the present disclosure. In some embodiments, a loop antenna system 500 can include a cable antenna 102. The cable antenna 102 can be a flexible coaxial cable including a Teflon outside coating. For example, the cable antenna 102 can be a radio guide antenna (e.g., RG-174, RG-316, or RG-58), a low loss antenna (e.g., LMR-100 or LMR-240), or a micro-coaxial cable (e.g., a 1.13mm or 1.32mm cable). In some embodiments, the cable antenna 102 can be a semi-rigid coaxial cable including a solid metal outer sheath (e.g., copper or aluminum). In some embodiments, the cable antenna 102 can be a conformable coaxial cable (e.g., a tin-filled copper braid). In some embodiments, the cable antenna 102 can be a rigid line antenna (e.g., comprising solid copper tubes). The cable antenna 102 can enable wireless communication for a variety of radio frequency (RF) bands, such as the RF bands disclosed with respect to FIG. 1 (above).

In some embodiments, the cable antenna 102 can be connected to a device 106 with a first ground 104 on a cable side of the cable antenna 102. The device 106 can be an electronic unit, that serves as the central processing hub for the signals received by the cable antenna 102. The device 106 can be connected to the cable antenna 102, enabling the transmission and reception of wireless signals. In some embodiments, the device 106 can be powered by device cables 108 including power supply lines for the device 106. In some embodiments, the device 106 can manage wireless data, such as LoRa or LTE signals, while providing the electrical grounding connection (e.g., first ground 104) to maintain signal efficiency.

In some embodiments, the first ground 104 can be integrated along the length of the cable antenna 102. The first ground 104 can be a soldered connection or a conductive strip that electrically connects the cable antenna 102 to a ground reference. In this way, the first ground 104 can mitigate signal attenuation caused by the long cable length, functioning as a tuning element to improve the cable antenna’s 102 efficiency. The loop antenna system 500 can include a second ground 310 located at an end of the cable antenna 102 (such as at an end of the connecting cable portion), where the cable antenna 102 connects to the device 106. In combination with the first ground 104, the second ground 310 serves to further increase the efficiency of the cable antenna 102.

The loop antenna system 500 can include an antenna loop 502 to further increase the efficiency of the cable antenna 102. The antenna loop 502 can include one or more loops formed by winding the cable antenna 102. In this way, the antenna loop 502 functions as an isolated magnetic decoupler to optimize signal transmission. For example, the antenna loop 502 can decouple the specific portion of the cable antenna 102 that connects the antenna loop 502 back to the device 106 (e.g., the connecting cable portion). By functioning as an isolated magnetic decoupler, the antenna loop 502 can isolate the long length of the connecting cable so that it does not act as part of the cable antenna’s 102 resonant structure or contribute to signal loss. This separation ensures that only the extended antenna portion (e.g., the segment extending outward from the antenna loop 502 which is configured to receive RF signals) functions as the active radiating element of the cable antenna 102. In some embodiments, the antenna loop 502 includes about one to about three loops, such as about one and a half loops (e.g., windings of the cable antenna 102 in a circular formation).

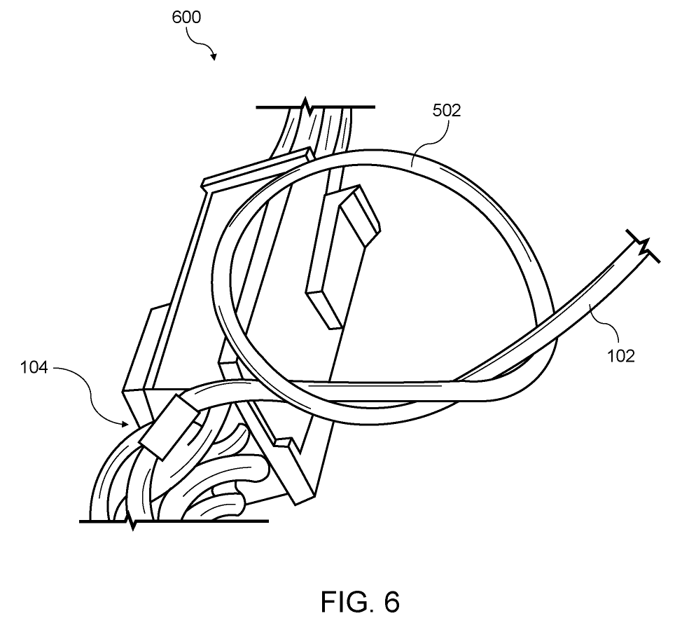

FIG. 6 provides a detailed view of an antenna loop according to example embodiments of the present disclosure. In some embodiments, a soldered ground loop antenna 600 includes the antenna loop 502 along with the first ground 104 on the cable antenna 102. In some embodiments, the antenna loop 502 can be configured with various diameters. For example, the antenna loop 502 can have a diameter of about 5mm to about 30mm, such as about 10mm to about 20mm, such as about 15mm. While the soldered ground loop antenna 600 includes the first ground 104, the antenna loop 502 can increase signal integrity, allowing the system to achieve high efficiency without requiring additional soldered grounding components.

In some embodiments, the antenna loop 502 is an air loop, without a loop support element to hold the shape of the loop. However, in some embodiments, such as embodiments including a cable antenna 102 with a slippery Teflon coating, one or more components to hold the shape of the antenna loop 502 may be desirable.

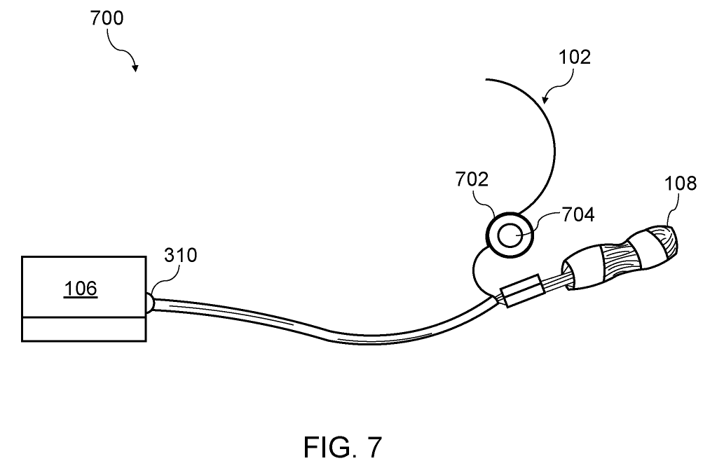

FIG. 7 provides a loop antenna system including a loop support according to example embodiments of the present disclosure. In some embodiments, a plastic loop cable antenna system 700 can include a cable antenna 102. The cable antenna 102 can be a flexible coaxial cable including a Teflon outside coating. For example, the cable antenna 102 can be a radio guide antenna (e.g., RG-174, RG-316, or RG-58), a low loss antenna (e.g., LMR-100 or LMR-240), or a micro-coaxial cable (e.g., a 1.13mm or 1.32mm cable). In some embodiments, the cable antenna 102 can be a semi-rigid coaxial cable including a solid metal outer sheath (e.g., copper or aluminum). In some embodiments, the cable antenna 102 can be a conformable coaxial cable (e.g., a tin-filled copper braid). In some embodiments, the cable antenna 102 can be a rigid line antenna (e.g., comprising solid copper tubes). The cable antenna 102 can enable wireless communication for a variety of radio frequency (RF) bands, such as the RF bands disclosed with respect to FIG. 1 (above).

In some embodiments, the cable antenna 102 can be connected to a device 106 with a first ground 104 on a cable side of the cable antenna 102. The device 106 can be an electronic unit, that serves as the central processing hub for the signals received by the cable antenna 102. The device 106 can be connected to the cable antenna 102, enabling the transmission and reception of wireless signals. In some embodiments, the device 106 can be powered by device cables 108 including power supply lines for the device 106. In some embodiments, the device 106 can manage wireless data, such as LoRa or LTE signals, while providing the electrical grounding connection (e.g., first ground 104) to maintain signal efficiency.

In some embodiments, the first ground 104 can be integrated along the length of the cable antenna 102. The first ground 104 can be a soldered connection or a conductive strip that electrically connects the cable antenna 102 to a ground reference. In this way, the first ground 104 can mitigate signal attenuation caused by the long cable length, functioning as a tuning element to improve the cable antenna’s 102 efficiency.

In some embodiments, the plastic loop cable antenna system 700 can include a circular antenna loop 702 within the cable antenna 102 that serves as an isolated magnetic decoupler. In some embodiments, the circular antenna loop 702 can be configured with various diameters. For example, the circular antenna loop 702 can have a diameter of about 5mm to about 30mm, such as about 10mm to about 20mm, such as about 15mm. In some embodiments, the circular antenna loop 702 can be mechanically secured by an antenna loop support 704. In this way, the plastic loop cable antenna system can ensure consistent performance, such as by avoiding a malformation of the circular antenna loop 702 by holding the circular antenna loop 702 in place.

The antenna loop support 704 can be a non-conductive material, such as plastic. In some embodiments, the antenna loop support 704 can maintain the circular antenna loop’s 702 structural integrity without interfering with its electrical performance. To ensure high-volume manufacturability, the antenna loop support 704 can be formed using injection molding to keep the shape and diameter of the circular antenna loop 702. In this way, the antenna loop support 704 can prevent a reduction in the efficiency of the circular antenna loop 702.

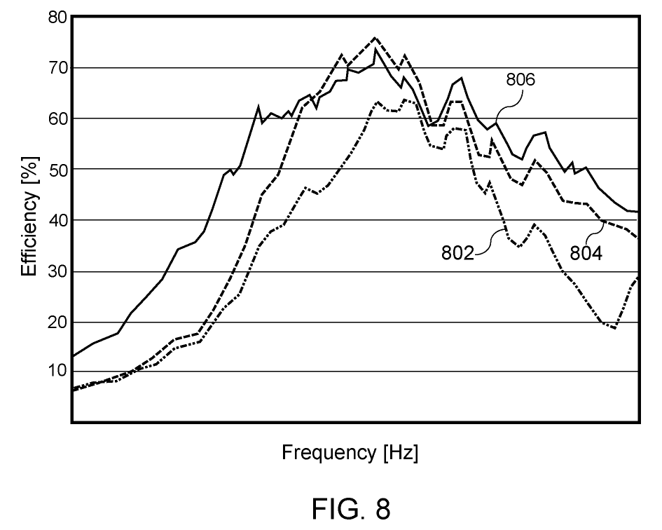

FIG. 8 provides an illustrative diagram of loop antenna efficiencies across multiple antenna loop diameters according to example embodiments of the present disclosure. A micro loop antenna efficiency 802 illustrates the performance of a circular antenna loop 702 with a small loop diameter (e.g., about 10mm). In some embodiments, at about 868MHz, the micro loop antenna efficiency 802 is about 35%, and at about 915MHz, the efficiency increases to about 62%.

The plastic loop antenna efficiency 804 illustrates the performance of the circular antenna loop 702 with a medium loop diameter (e.g., about 15mm). In some embodiments, at about 868MHz, the plastic loop antenna efficiency 804 is about 50%, while at about 915MHz, the efficiency increases to about 72%.

The loop antenna efficiency 806 illustrates the performance of a circular antenna loop 702 with a large loop diameter (e.g., about 22mm). In some embodiments, at about 868MHz, the loop antenna efficiency 806 is about 60%, while at about 915MHz, the efficiency increases to about 75%. Collectively, these efficiency curves demonstrate that modification of the diameter of the isolated magnetic decoupler loop can tune the antenna system.

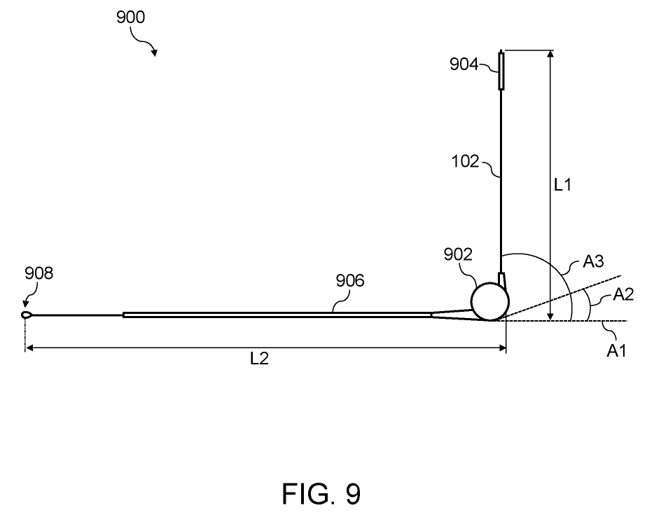

FIG. 9 provides a molded antenna loop system according to example embodiments of the present disclosure. In some embodiments, a molded loop cable antenna system 900 can include a cable antenna 102. The cable antenna 102 can be a flexible coaxial cable including a Teflon outside coating. For example, the cable antenna 102 can be a radio guide antenna (e.g., RG-174, RG-316, or RG-58), a low loss antenna (e.g., LMR-100 or LMR-240), or a micro-coaxial cable (e.g., a 1.13mm or 1.32mm cable). In some embodiments, the cable antenna 102 can be a semi-rigid coaxial cable including a solid metal outer sheath (e.g., copper or aluminum). In some embodiments, the cable antenna 102 can be a conformable coaxial cable (e.g., a tin-filled copper braid). In some embodiments, the cable antenna 102 can be a rigid line antenna (e.g., comprising solid copper tubes). The cable antenna 102 can enable wireless communication for a variety of radio frequency (RF) bands, such as the RF bands disclosed with respect to FIG. 1 (above).

In some embodiments, the molded loop cable antenna system 900 can include a molded antenna loop 902 including one or more loops of the cable antenna 102 that serves as an isolated magnetic decoupler inside a plastic mold. In some embodiments, the molded antenna loop 902 can be configured with various diameters. For example, the molded antenna loop 902 can have a diameter of about 5mm to about 30mm, such as about 10mm to about 20mm, such as about 15mm.

In some embodiments, the molded antenna loop 902 can maintain the structural integrity of the looped cable antenna 102 without interfering with its electrical performance. To ensure high-volume manufacturability, the molded antenna loop 902 can be formed using injection molding to keep the shape and diameter of the molded antenna loop 902. In this way, the molded antenna loop 902 can prevent a reduction in the efficiency of the cable antenna 102.

In some embodiments, the cable antenna 102 includes an antenna tip 904. For example, the cable antenna 102 can include an extended antenna portion which has an extended antenna body and an extended antenna tip. In some embodiments, the extended antenna portion can have an extended antenna portion length L1. The extended antenna portion length L1 can be about 50mm to about 300mm, such as about 120mm to about 220mm, such as about 150mm to about 190mm, such as about 170mm. In some embodiments, the extended antenna tip can have a greater rigidity than the extended antenna body. In some embodiments, the antenna tip 904 is the rigid radiating component located at the distal end of the cable antenna 102, for transmitting and receiving wireless signals.

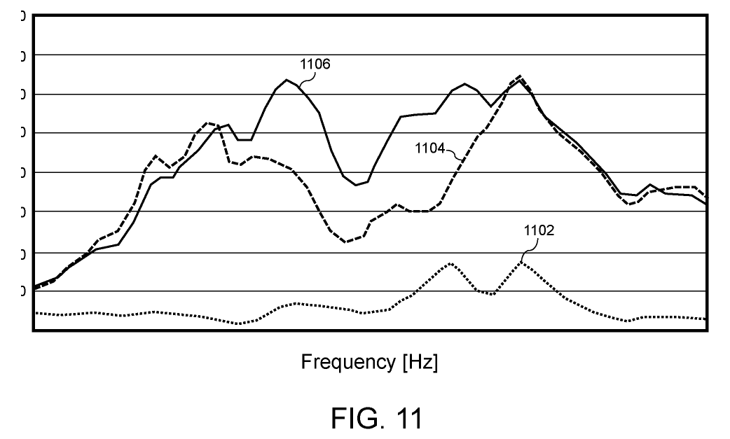

In some embodiments, the cable antenna 102 includes a connecting cable portion 906 configured to connect the cable antenna to a device. In some embodiments, the connecting cable portion 906 can have a connecting cable portion length L2. The connecting cable portion length L2 can be about 100mm to about 500mm, such as about 200mm to about400 mm, such as about 300mm. In some embodiments, the cable antenna 102 can be at a first angle A1 with respect to the connecting cable portion 906. For example, A1 can be about 60 degrees to about 120 degrees, such as about 90 degrees with respect to the connecting cable portion 906. In some embodiments, the cable antenna 102 can be at a second angle A1 with respect to the connecting cable portion 906. For example, A2 can be about 15 degrees to about 45 degrees, such as about 30 degrees with respect to the connecting cable portion 906. In some embodiments, the cable antenna 102 can be at a third angle A3 with respect to the connecting cable portion 906. For example, A3 can be about -15 degrees to about 15 degrees, such as about 0 degrees with respect to the connecting cable portion 906 (e.g., in a straight line with respect to the connecting cable portion 906). The chosen angle of the cable antenna 102 can change the efficiency of the received RF signal, as discussed in further detail with respect to FIG. 11 below.

In some embodiments, the connecting cable portion 906 can connect the connector 908 at a circuit board to the molded antenna loop 902. Due to the length of the connecting cable portion 906, this cable segment can act as a parasitic element that attenuates the signal, causing overall efficiency to drop to about 15% in some embodiments. However, the molded antenna loop 902 functions as an isolated magnetic decoupler, effectively isolating the connecting cable portion 906 from attenuating an RF signal received by the cable antenna 102. Furthermore, the isolated magnetic decoupler technology (e.g., molded antenna loop 902) decouples the signal currents received at the antenna tip 904 from any nearby signal at a nearby antenna, preventing crosstalk and ensuring that the performance of each antenna remains undegraded by the presence of another assembly.

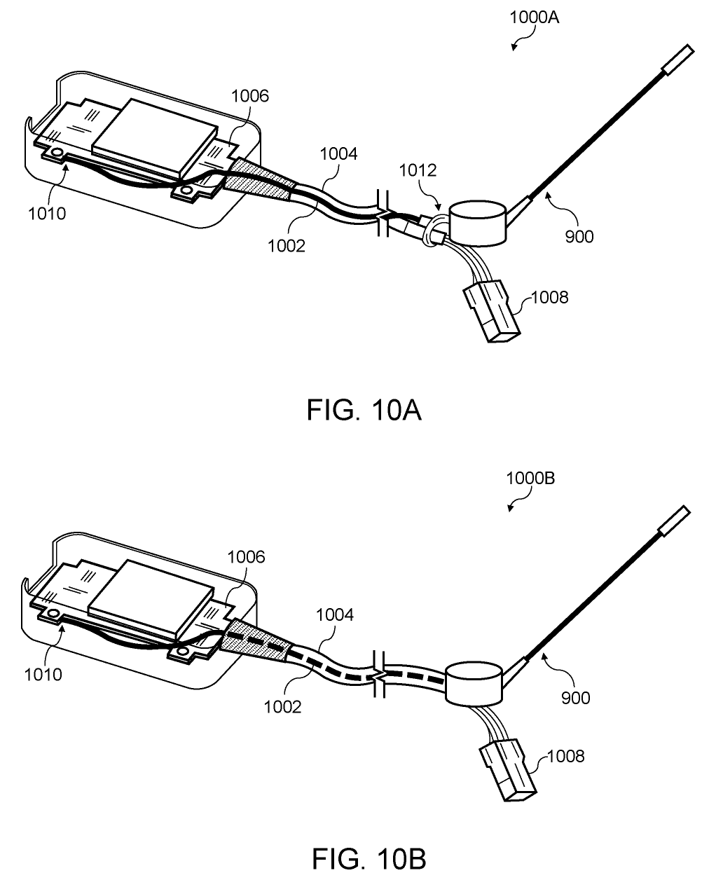

FIG. 10A provides an attached molded antenna loop system according to example embodiments of the present disclosure. The attached molded antenna loop system 1000A can include the molded antenna loop system 900 being attached to a second RF system. Due to the molded antenna loop 902 of the molded antenna loop system 900, there is minimal cross talk between the second RF system and the molded antenna loop system 900 when attached to one another in the attached molded antenna loop system 1000A. Therefore, a single circuit board 1006 can connect (e.g., via circuit board connector 1010) to the molded antenna loop system 900 as well as the second RF system, with the second RF system being powered by one or more second RF system device cables 1008 (including power supply lines for the circuit board 1006). In some embodiments, the second RF system can include a first antenna electrically connected to the circuit board. In some embodiments, to support the molded antenna loop system 900 in the attached molded antenna loop system 1000A, the molded antenna loop system 900 can have the attached connector cable 1002 sitting on top of a second RF system connector cable 1004, being attached by a flexible cable connector 1012. In some embodiments, the attached connector cable 1002 can be an externally attached version of the connecting cable portion 906 of FIG. 9, configured to connect the cable antenna 102 to a device (such as the circuit board 1006). In some embodiments, the flexible cable connector 1012 can be, for example, a zip tie, or another method for quickly and securely attaching separate wires (e.g., adhesive tape, Velcro, twist ties, etc.). In this way, the molded antenna loop system 900 can be attached to the second RF system without incurring a large manufacturing expense, and without introducing cross talk to either the second RF system or the molded antenna loop system 900, while increasing the efficiency of the molded antenna loop system 900 by decoupling losses created by the length of the attached connector cable 1002.

FIG. 10B provides an embedded molded antenna loop system according to example embodiments of the present disclosure. The embedded molded antenna loop system 1000B can include the molded antenna loop system 900 being embedded in the second RF system. Due to the molded antenna loop 902 of the molded antenna loop system 900, there is minimal cross talk between the second RF system and the molded antenna loop system 900 even when an embedded connector cable 1003 is included with the second RF system connector cable 1004 (e.g., sharing a plastic coating).

A single circuit board 1006 can connect (e.g., via circuit board connector 1010) to the molded antenna loop system 900 as well as the second RF system, with the second RF system being powered by one or more second RF system device cables 1008 (including power supply lines for the circuit board 1006). In some embodiments, the second RF system can include a first antenna electrically connected to the circuit board. In some embodiments, the embedded connector cable 1003 can be a version of the connecting cable portion 906 of FIG. 9, configured to connect the cable antenna 102 to a device (such as the circuit board 1006). In this way, the molded antenna loop system 900 can be manufactured with the second RF system rather than requiring separate manufacturing and attachment, as in the attached molded antenna loop system 1000A. In this way, the embedded molded antenna loop system 1000B can receive RF signals for the second RF system and the molded antenna loop system 900 without introducing cross talk to either the second RF system or the molded antenna loop system 900, while increasing the efficiency of the molded antenna loop system 900 by decoupling losses created by the length of the embedded connector cable 1003.

FIG. 11 provides an illustrative diagram of loop antenna efficiencies across multiple antenna angles according to example embodiments of the present disclosure. A first angular cable efficiency 1102 illustrates the performance of the molded antenna loop system 900 at the first angle A1. In some embodiments, at about 868MHz, the first angular cable efficiency 1102 is about 3%, while at about 915MHz, the efficiency is about 11%. In this illustrative example, the peak efficiency of the first angular cable efficiency 1102 is about 15% to about 20%, such as about 18%.

A second angular cable efficiency 1104 illustrates the performance of the molded antenna loop system 900 at the second angle A2. In some embodiments, at about 868MHz, the second angular cable efficiency 1104 is about 44%, while at about 915MHz, the efficiency is about 33%. In this illustrative example, the peak efficiency of the second angular cable efficiency 1104 is about 60% to about 65%, such as about 63%.

A third angular cable efficiency 1106 illustrates the performance of the molded antenna loop system 900 at the third angle A3. In some embodiments, at about 868 MHz, the third angular cable efficiency 1106 is about 54%, while at about 915MHz, the efficiency is about 55%. In this illustrative example, the peak efficiency of the third angular cable efficiency 1106 is about 60% to about 65%, such as about 63%. However, across the measured frequency band in this illustrative examples (e.g., a LoRa frequency band) these peaks happen more frequently at the third angular cable efficiency 1106 and further maintain a higher efficiency across a variety of measured frequencies than either the second angular cable efficiency 1104 or the first angular cable efficiency 1102. Collectively, these curves demonstrate that the physical placement of the cable antenna 102 (e.g., the angle relative to the cable connecting portion 906) can tune the efficiency of the molded antenna loop system 900. Specifically, the illustrative diagram of loop antenna efficiencies across multiple antenna angles demonstrates that orienting the antenna nearly perpendicular to the wire harness can maximize the radiation efficiency of the RF signal received by the cable antenna 102.

One example aspect of the present disclosure is directed to an antenna system. The antenna system includes a cable antenna. The cable antenna includes an extended antenna portion configured to receive radio frequency signals. The cable antenna further includes a connecting cable portion configured to connect the cable antenna to a device. The cable antenna further includes an antenna loop between the extended antenna portion and the connecting cable portion, the antenna loop comprising one or more loops of the cable antenna.

In some examples, the antenna loop includes about one loop to about three loops of the cable antenna.

In some examples, the antenna system further includes a ground at a connection end of the connecting cable portion.

In some examples, the antenna loop includes a diameter of about 10mm to about 30mm.

In some examples, the extended antenna portion includes an extended antenna portion length of about 120 mm to about 220 mm.

In some examples, the connecting cable portion includes a connecting cable portion length of about 200mm to about 400mm.

In some examples, the radio frequency signals are about 600MHz to about 1000MHz.

In some examples, the radio frequency signals are about 1700MHz to about 2800MHz.

In some examples, the radio frequency signals are about 2GHz to about 4GHz.

In some examples, the extended antenna portion includes an extended antenna body and an extended antenna tip, the extended antenna tip having a greater rigidity than the extended antenna body.

In some examples, the extended antenna portion extends at about a 90-degree angle from the connecting cable portion.

Another example aspect of the present disclosure is directed to an antenna system. The antenna system includes a cable antenna. The cable antenna includes an extended antenna portion. The cable antenna further includes a connecting cable portion. The cable antenna further includes an antenna loop between the extended antenna portion and the connecting cable portion, the antenna loop comprising one or more loops of the cable antenna. The cable antenna further includes an antenna loop support configured to retain the antenna loop in a looped configuration.

In some examples, the antenna loop support includes plastic.

In some examples, the antenna loop includes about one loop to about three loops of the cable antenna.

In some examples, the antenna loop includes a diameter of about 10mm to about 30mm.

In some examples, the extended antenna portion includes a extended antenna portion length of about 120mm to about 220mm and the connecting cable portion includes a connecting cable portion length of about 200mm to about 400mm.

In some examples, the extended antenna portion extends at about a 90-degree angle from the connecting cable portion.

Another example aspect of the present disclosure is directed to an antenna system. The antenna system includes a circuit board. The antenna system further includes a first antenna electrically connected to the circuit board. The antenna system further includes a wire harness including one or more electrical cables. The antenna system further includes a cable antenna. The cable antenna includes an extended antenna portion configured to receive radio frequency signals. The cable antenna further includes a connecting cable portion configured to connect the cable antenna to the circuit board. The cable antenna further includes an antenna loop between the extended antenna portion and the connecting cable portion, the antenna loop comprising one or more loops of the cable antenna.

In some examples, the connecting cable portion is included in the wire harness.

In some examples, the connecting cable portion is not included in the wire harness.

While the present subject matter has been described in detail with respect to specific example embodiments thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. An antenna system comprising:
a cable antenna, the cable antenna comprising:
an extended antenna portion configured to receive radio frequency signals;
a connecting cable portion configured to connect the cable antenna to a device; and
an antenna loop between the extended antenna portion and the connecting cable portion, the antenna loop comprising one or more loops of the cable antenna.

2. The antenna system of claim 1, wherein the antenna loop comprises about one loop to about three loops of the cable antenna.

3. The antenna system of claim 1, further comprising a ground at a connection end of the connecting cable portion.

4. The antenna system of claim 1, wherein the antenna loop comprises a diameter of about 10mm to about 30mm.

5. The antenna system of claim 1, wherein the extended antenna portion comprises a extended antenna portion length of about 120mm to about 220mm.

6. The antenna system of claim 1, wherein the connecting cable portion comprises a connecting cable portion length of about 200mm to about 400mm.

7. The antenna system of claim 1, wherein the radio frequency signals are about 600MHz to about 1000MHz.

8. The antenna system of claim 1, wherein the radio frequency signals are about 1700MHz to about 2800MHz.

9. The antenna system of claim 1, wherein the radio frequency signals are about 2GHz to about 4GHz.

10. The antenna system of claim 1, wherein the extended antenna portion comprises an extended antenna body and an extended antenna tip, the extended antenna tip having a greater rigidity than the extended antenna body.

11. The antenna system of claim 1, wherein the extended antenna portion extends at about a 90-degree angle from the connecting cable portion.

12. An antenna system comprising:
a cable antenna, the cable antenna comprising:
an extended antenna portion;
a connecting cable portion; and
an antenna loop between the extended antenna portion and the connecting cable portion, the antenna loop comprising one or more loops of the cable antenna; and
an antenna loop support configured to retain the antenna loop in a looped configuration.

13. The antenna system of claim 12, wherein the antenna loop support comprises plastic.

14. The antenna system of claim 12, wherein the antenna loop comprises about one loop to about three loops of the cable antenna.

15. The antenna system of claim 12, wherein the antenna loop comprises a diameter of about 10mm to about 30mm.

16. The antenna system of claim 12, wherein extended antenna portion comprises a extended antenna portion length of about 120mm to about 220mm and the connecting cable portion comprises a connecting cable portion length of about 200mm to about 400mm.

17. The antenna system of claim 12, wherein the extended antenna portion extends at about a 90-degree angle from the connecting cable portion.

18. An antenna system comprising:
a circuit board;
a first antenna electrically connected to the circuit board;
a wire harness comprising one or more electrical cables; and
a cable antenna, the cable antenna comprising:
an extended antenna portion configured to receive radio frequency signals;
a connecting cable portion configured to connect the cable antenna to the circuit board; and
an antenna loop between the extended antenna portion and the connecting cable portion, the antenna loop comprising one or more loops of the cable antenna.

19. The antenna system of claim 18, wherein the connecting cable portion is included in the wire harness.

20. The antenna system of claim 18, wherein the connecting cable portion is not included in the wire harness.
